(19) United States
(12) Patent Application Publication
(10) Pub. No.: US 2022/0147079 A1
(43) Pub. Date: May 12, 2022

(54) SENSOR MODULE

(71) Applicant: AISIN CORPORATION, Kariya (JP)

(72) Inventors: Saya KOBAYASHI, Kariya-shi (JP); Takaaki KOIZUMI, Kariya-shi (JP)

(73) Assignee: AISIN CORPORATION, Kariya (JP)

(21) Appl. No.: 17/512,740

(22) Filed: Oct. 28, 2021

(30) Foreign Application Priority Data
Nov. 6, 2020 (JP) 2020-185723

(51) Int. Cl. G05F 1/46

(52) U.S. Cl. CPC G05F 1/46

(57) ABSTRACT

A sensor module includes: a module side connection unit connected to a power source via a power source side connection unit; a control IC energized from the power source via the power source side connection unit and the module side connection unit and configured to control a sensor; a first power source line provided across the module side connection unit and the control IC; an increase instruction unit configured to issue an instruction to increase a current flowing through the power source side connection unit and the module side connection unit; and a current increase unit provided across the first power source line and a second power source line to which a potential lower than that of the first power source line is applied, and configured to increase the current in accordance with the instruction of the increase instruction unit.

### CROSS REFERENCE TO RELATED APPLICATIONS

This application is based on and claims priority under 35 U.S.C. § 119 to Japanese Patent Application 2020-185723, filed on Nov. 6, 2020, the entire content of which is incorporated herein by reference.

### TECHNICAL FIELD

The disclosure relates to a sensor module including a control IC that is supplied with electric power from the outside via a connector and controls a sensor.

### BACKGROUND DISCUSSION

In the related art, a sensor module including a control IC for controlling a sensor has been used. Such a sensor module shares electric power from the outside via a connector (for example, JP 2018-40186A (Reference 1)).

Reference 1 describes a door handle device for a vehicle. The door handle device for a vehicle is used to lock and unlock a vehicle door, and a sensor unit (a lock detection region and an unlock detection region) that detects locking and unlocking of the door is provided in an outside door handle provided in a door outer panel. The sensor unit is controlled by a sensor IC, and the sensor IC is supplied with electric power from a drive ECU that is connected by a first electric wire and a second electric wire. One end of the first electric wire is connected to a first control unit side terminal, and the other end of the first electric wire is connected to a first module side terminal. In addition, one end of the second electric wire is connected to a second control unit side terminal, and the other end of the second electric wire is connected to a second module side terminal.

It is known that, for example, when two terminals are connected by using a connector or the like, if tin plating is applied to the two terminals, an insulating film (oxide film) may be formed on each of the two terminals, and the conductivity may be deteriorated. Therefore, as in a technique described in JP 2013-177654A (Reference 2), it is conceivable to apply gold plating to a terminal.

However, in the technique described in Reference 2, the cost of gold-plated material is increased, and as a result, the cost of the sensor module is increased.

A need thus exists for a sensor module which is not susceptible to the drawback mentioned above.

### SUMMARY

A feature of a sensor module according to this disclosure is that the sensor module includes: a module side connection unit connected to a power source via a power source side connection unit; a control IC energized from the power source via the power source side connection unit and the module side connection unit and configured to control a sensor; a first power source line provided across the module side connection unit and the control IC; an increase instruction unit configured to issue an instruction to increase a current flowing through the power source side connection unit and the module side connection unit; and a current increase unit provided across the first power source line and a second power source line to which a potential lower than that of the first power source line is applied, and configured to increase the current in accordance with the instruction of the increase instruction unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram illustrating a configuration of a sensor module;

FIG. 2 is a timing chart illustrating an operation of the sensor module;

FIG. 3 is a flowchart illustrating a process of the sensor module;

FIG. 4 is a block diagram illustrating a configuration of a sensor module according to another embodiment;

FIG. 5 is a block diagram illustrating a configuration of a sensor module according to still another embodiment; and

FIG. 6 is a block diagram illustrating a configuration of a sensor module according to yet another embodiment.

### DETAILED DESCRIPTION

A sensor module according to an embodiment disclosed here is configured such that a current flowing through a power source line used for energization can be increased. Hereinafter, a sensor module 1 of the present embodiment will be described.

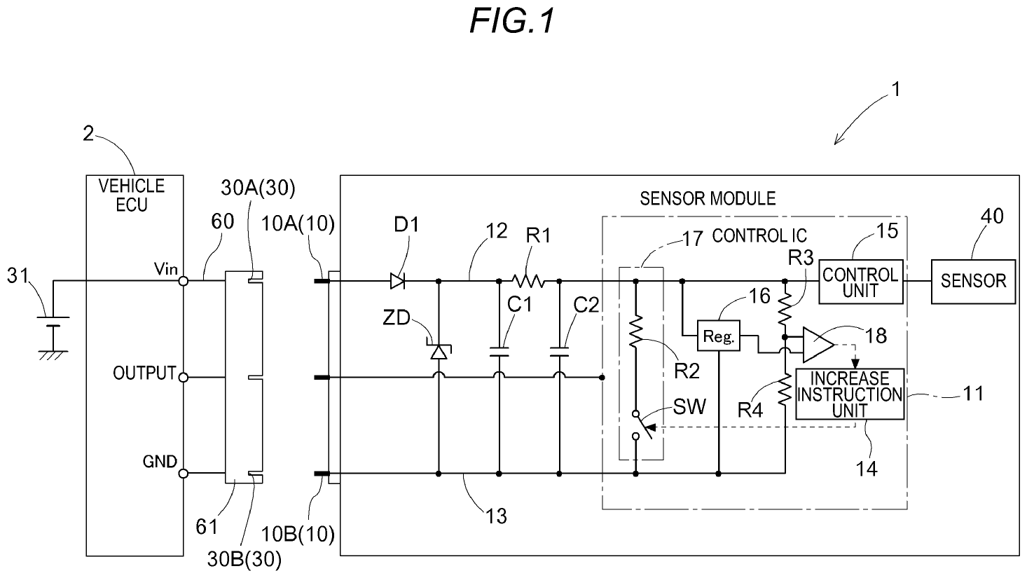

FIG. 1 is a block diagram schematically illustrating a configuration of the sensor module 1 of the present embodiment. As illustrated in FIG. 1, the sensor module 1 includes a module side connection unit 10, a control IC 11, a first power source line 12, an increase instruction unit 14, a current increase unit 17, and a detection unit 18, and each functional unit is configured by hardware, software, or both of hardware and software using a CPU as a core member in order to perform processing related to an increase in a current flowing through a power source line.

The module side connection unit 10 is connected to a power source 31 via a power source side connection unit 30. Here, in the present embodiment, an example in which the sensor module 1 controls an operation of a sensor (for example, a capacitive sensor) 40 that detects a user operation for controlling opening and closing of a door (for example, a slide door) of a vehicle will be described. In addition, in the present embodiment, the power source side connection unit 30 corresponds to a terminal 30A of a connector 61 connected to a positive terminal 10A of a harness 60 connecting a Vin terminal of a vehicle ECU 2 and the positive terminal 10A of the sensor module 1. In addition, the power source 31 corresponds to a battery mounted in the vehicle. Therefore, the module side connection unit 10 is connected to the battery that is mounted in the vehicle via the power source side connection unit 30 of the connector 61 in the harness 60. In the present embodiment, the module side connection unit 10 includes the positive terminal 10A to which electric power is supplied from the vehicle ECU 2 to the sensor module 1 and a negative terminal 10B to which a reference potential (a GND potential) is applied. Therefore, the power source side connection unit 30 includes not only the terminal 30A described above but also a terminal 30B connected to the negative terminal 10B.

The control IC 11 is energized from the power source 31 via the power source side connection unit 30 and the module side connection unit 10, and controls the sensor 40. Therefore, the control IC 11 is connected to the power source 31 and the sensor 40. In the present embodiment, a control unit 15 is provided in the control IC 11, and the control unit 15 controls the sensor 40. The control of the sensor 40 by the control unit 15 is not particularly limited, and a description thereof will be omitted here.

The first power source line 12 is provided across the module side connection unit 10 and the control IC 11. The expression “provided across the module side connection unit 10 and the control IC 11” means that the first power source line 12 is provided such that electric power supplied from the power source 31 can be transmitted to the control IC 11 via the module side connection unit 10. As illustrated in FIG. 1, the first power source line 12 may include a protection diode D1 and a current limiting resistor R1.

In addition, as described above, the module side connection unit 10 includes the negative terminal 10B connected to the GND potential of the vehicle ECU 2 via the terminal 30B, and a reference terminal of the control IC 11 is connected to the negative terminal 10B via a second power source line 13. A protection Zener diode ZD and a capacitor Cl and a capacitor C2 that smooth voltage and current pulsations are provided across the first power source line 12 and the second power source line 13.

The increase instruction unit 14 issues an instruction to increase a current flowing through the power source side connection unit 30 and the module side connection unit 10. The current flowing through the power source side connection unit 30 and the module side connection unit 10 is a current flowing from the power source 31 to the power source side connection unit 30 and the module side connection unit 10. In the present embodiment, the increase instruction unit 14 issues an instruction to increase the current flowing through the power source side connection unit 30 and the module side connection unit 10 in accordance with a voltage value of a voltage applied to the control IC 11.

In the present embodiment, the detection unit 18 detects a potential difference of the first power source line 12 with respect to the second power source line 13. Specifically, the voltage applied to the control IC 11 is stepped down to a predetermined voltage value by a regulator 16, and is input to one input terminal of a comparator. In addition, a voltage obtained by dividing the voltage applied to the control IC 11 by a resistor R3 and a resistor R4 is applied to the other input terminal of the comparator. Therefore, the detection unit 18 determines whether the voltage applied to the control IC 11 is higher (lower) than a predetermined voltage value, that is, detects a potential difference between the voltage applied to the control IC 11 and the predetermined voltage value.

A detection result of the detection unit 18 is transmitted to the increase instruction unit 14, and when the detection result of the detection unit 18 is out of a preset range, an instruction (an instruction to increase the current) is issued. Specifically, the increase instruction unit 14 issues an instruction to increase the current in accordance with a determination result transmitted from the detection unit 18, that is, a determination result as to whether the voltage applied to the control IC 11 is higher (lower) than the predetermined voltage value (the predetermined voltage value stepped down by the regulator 16). The predetermined voltage value stepped down by the regulator 16 corresponds to a threshold value at which the increase instruction unit 14 issues an instruction. In the present embodiment, the increase instruction unit 14 issues an instruction to increase the current when the voltage applied to the control IC 11 is smaller than the predetermined voltage value.

The current increase unit 17 is provided across the first power source line 12 and the second power source line 13 to which a potential lower than that of the first power source line 12 is applied, and increases the current in accordance with the instruction from the increase instruction unit 14. In the present embodiment, “provided across the first power source line 12 and the second power source line 13 to which a potential lower than that of the first power source line 12 is applied” means that one end is connected to the first power source line 12 to which the electric power from the power source 31 is supplied, and the other end is connected to the second power source line 13 to which the GND potential is applied. Increasing the current in accordance with the instruction from the increase instruction unit 14 means increasing the current by receiving an instruction in accordance with the determination result transmitted from the detection unit 18 by the increase instruction unit 14, that is, the determination result as to whether the voltage applied to the control IC 11 is higher (lower) than the predetermined voltage value.

In the present embodiment, the current increase unit 17 includes a resistor R2 and a switch SW. One terminal of the resistor R2 is connected to the first power source line 12, and the other terminal of the resistor R2 is connected to one terminal of the switch SW. The other terminal of the switch SW is connected to the second power source line 13. Therefore, the switch SW is connected in series with the resistor R2. The resistor R2 sets a current value of a current to be increased in the power source side connection unit 30 and the module side connection unit 10 in accordance with the instruction of the increase instruction unit 14. Specifically, it is preferable to decrease the resistance value of the resistor R2 as the current to be increased is increased, and it is preferable to increase the resistance value of the resistor R2 as the current to be increased is decreased. The switch SW is controlled to be opened and closed in accordance with the instruction of the increase instruction unit 14. That is, the switch SW is set to a closed state when an instruction to increase the current is received from the increase instruction unit 14, and the switch SW is set to an opened state when an instruction to increase the current is not received from the increase instruction unit 14. Accordingly, when an instruction to increase the current is received from the increase instruction unit 14, a current having a current value obtained by dividing the potential difference between the first power source line 12 and the second power source line 13 by the resistance value of the resistor R2 can be caused to flow from the first power source line 12 to the second power source line 13.

In the present embodiment, the resistor R2 and the switch SW are incorporated in the control IC 11. Accordingly, the resistor R2 and the switch SW can be configured to be compact as compared with a case where the resistor R2 and the switch SW are not incorporated in the control IC 11.

In addition, when an instruction to increase the current is received from the increase instruction unit 14, the current increase unit 17 causes a current having a current value obtained by dividing the potential difference between the first power source line 12 and the second power source line 13 by the resistance value of the resistor R2 to flow from the first power source line 12 to the second power source line 13, and it is preferable that the current value of the current after the increase is a current value at which the insulating film formed on at least one of the power source side connection unit 30 and the module side connection unit 10 can be dielectrically broken. Accordingly, an insulator (an oxide film) formed by oxidation of the terminals (the positive terminal 10A, the negative terminal 10B, the terminal 30A, and the terminal 30B) in the power source side connection unit 30 and the module side connection unit 10 can be dielectrically broken by the current increased by the current increase unit 17.

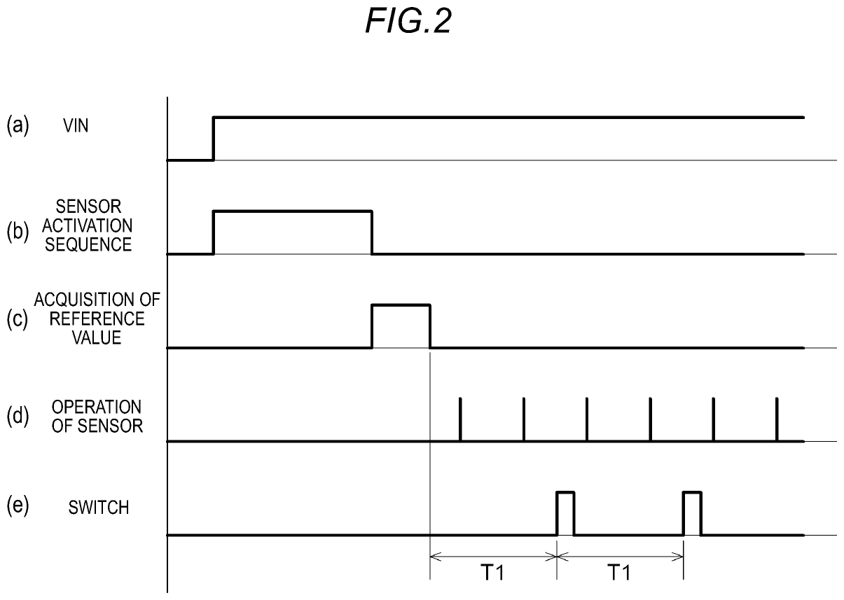

FIG. 2 is a timing chart illustrating the operation of the sensor module 1. As illustrated in FIG. 2, when the control IC 11 is energized as illustrated in (a), initialization is performed as illustrated in (b). In FIG. 2, a “sensor activation sequence” is illustrated. Therefore, the increase instruction unit 14 is configured to issue an instruction after completion of activation of the sensor 40. Accordingly, the initialization of the sensor 40 can be appropriately performed together with the initialization of the control IC 11.

In addition, the increase instruction unit 14 is configured to issue an instruction after a preset time elapses after start of energization of the control IC 11. The preset time is, for example, a time related to a state where oxide films formed on the power source side connection unit 30 and the module side connection unit 10 have little influence on energization. For example, as illustrated in (e) of FIG. 2, a predetermined process (for example, acquisition of a reference value ((c) of FIG. 2)) is performed after the sensor activation sequence, and then the increase instruction unit 14 issues an instruction every time a preset time T1 elapses, so that the current can be periodically increased, and the formation of the oxide films can be prevented.

In addition, for example, as illustrated in (d) of FIG. 2, the control IC 11 drives the sensor 40 at a predetermined time interval. In this case, as illustrated in (e) of FIG. 2, the increase instruction unit 14 issues an instruction when the control IC 11 does not drive the sensor 40. Accordingly, communication with the sensor 40 by the control IC 11 cannot be interfered.

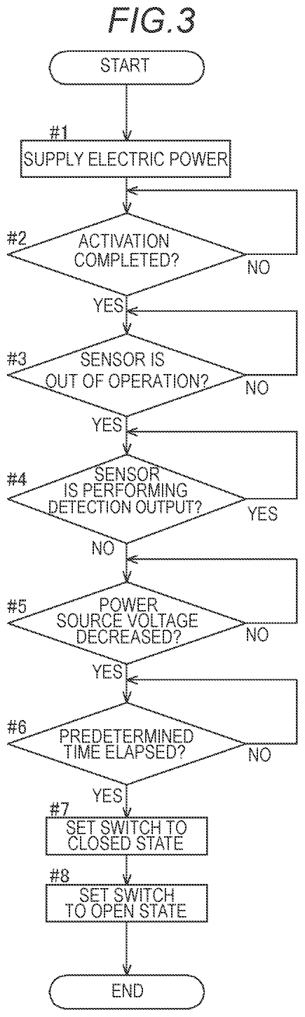

Next, a process of the sensor module 1 will be described with reference to the flowchart of FIG. 3. First, the electric power is supplied from the power source 31 to the sensor module 1 via the power source side connection unit 30 and the module side connection unit 10 (step #1). After the electric power supply, if the activation of the sensor module 1 and the sensor 40 is not completed (step #2: No), the process is suspended. If the activation of the sensor module 1 and the sensor 40 is completed (step #2: Yes), it is checked whether the sensor 40 is in operation. If the sensor 40 is in operation (step #3: No), the process is suspended. If the sensor 40 is out of operation (step #3: Yes), it is checked whether the sensor 40 is performing detection output, that is, whether the control IC 11 is in communication with the sensor 40.

If the sensor 40 is performing detection output (step #4: Yes), the process is suspended. If the sensor 40 is not performing detection output (step #4: No), it is checked whether the power source voltage (the voltage value of the voltage applied from the power source 31) is decreased, that is, whether the power source voltage is out of the preset range. If the power source voltage is not decreased (step #5: No), the process is suspended. If the power source voltage is decreased (step #5: Yes), it is checked whether the preset time elapses after the start of energization of the control IC 11.

If the preset time does not elapse after the start of energization of the control IC 11 (step #6: No), the process is suspended. If the preset time elapses after the start of energization of the control IC 11 (step #6: Yes), the increase instruction unit 14 issues an instruction to increase the current. In response to the instruction, the switch SW is set to the closed state for a predetermined time (step #7). Thereafter, the increase instruction unit 14 stops the instruction to increase the current. In response to the stop of the instruction, the switch SW is set to the opened state (step #8), and the process ends. Thus, the sensor module 1 performs processing. At this time, a time for which the switch SW is closed may be changed in accordance with the amount of decrease in the power source voltage described above.

In the flowchart illustrated in FIG. 3, it is described that step #2 to step #6 are performed as determination processing of situations. For example, the sensor module 1 performs processing including a flowchart of step #1 and step #6 to step #8, so that the switch SW can be periodically controlled to be opened or closed, and generation of an oxide film can be prevented. In addition, the sensor module 1 may perform processing including a flowchart of step #1, step #2, and step #6 to step #8, or may perform processing including a flowchart of step #1, step #3, and step #6 to step #8. Furthermore, the sensor module 1 may also perform processing including a flowchart of step #1, step #4, and step #6 to step #8. In these cases, the sensor 40 can be appropriately controlled, and generation of an oxide film can be prevented. Furthermore, the sensor module 1 may also perform processing including a flowchart of step #1, step #5, and step #7 to step #8. In this case, a decrease in an output voltage of the power source 31 can be prevented. Certainly, it is not limited to the combination other than the above, and the steps can be combined as appropriate in the flowchart of FIG. 3.

### Other Embodiments

In the above embodiment, an example in which the sensor module 1 controls the operation of the sensor (for example, a capacitive sensor) 40 that detects a user operation for controlling opening and closing of a door (for example, a slide door) of a vehicle has been described, but the sensor module 1 may be those that control an operation of another sensor (for example, an ultrasonic sensor, an infrared sensor, a strain gauge sensor, or the like). In addition, the door of the vehicle may be a swing door or a back door.

The above embodiment has been described in which the power source side connection unit 30 corresponds to the terminal 30A of the connector 61 connected to the positive terminal 10A, of the harness 60 connecting the Vin terminal of the vehicle ECU 2 and the positive terminal 10A of the sensor module 1, but the power source side connection unit 30 may be a terminal of a connector connected to the Vin terminal, of the harness 60 connecting the Vin terminal of the vehicle ECU 2 and the positive terminal 10A of the sensor module 1.

The above embodiment has been described in which the current value of the current after the increase is a current value at which the insulating film formed on at least one of the power source side connection unit 30 and the module side connection unit 10 can be dielectrically broken, but the current value of the current after the increase may be a current value at which the insulating films formed on both the power source side connection unit 30 and the module side connection unit 10 can be dielectrically broken.

The above embodiment has been described in which the increase instruction unit 14 issues an instruction to increase the current after a preset time elapses after the start of energization of the control IC 11, but the increase instruction unit 14 can be configured to issue an instruction to increase the current immediately after the start of energization of the control IC 11.

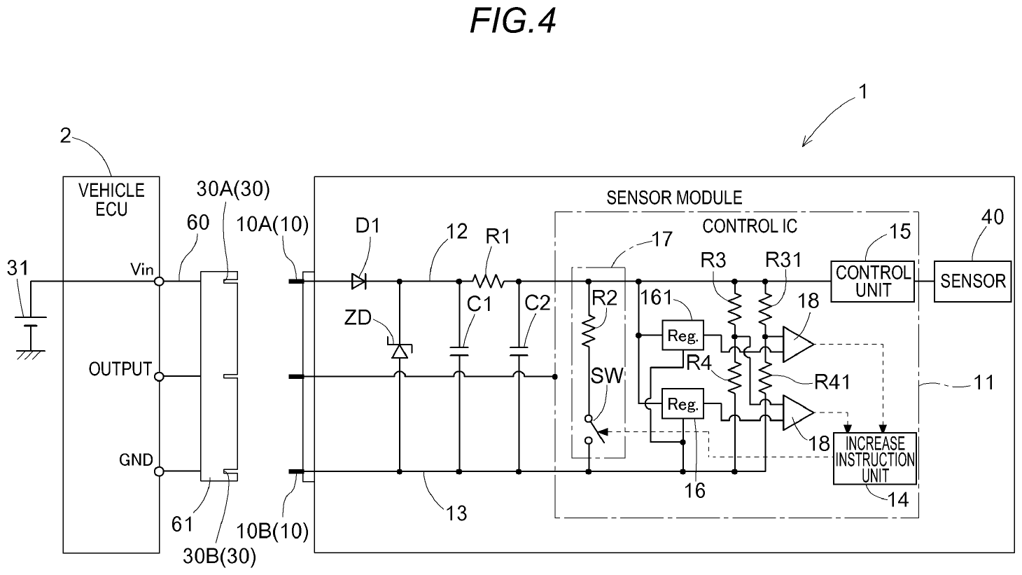

The above embodiment has been described in which the sensor module 1 further includes the detection unit 18 configured to detect the potential difference of the first power source line 12 with respect to the second power source line 13, and the increase instruction unit 14 issues an instruction when the detection result of the detection unit 18 is out of a preset range. Specifically, it is described that the increase instruction unit 14 determines whether the voltage applied to the control IC 11 is higher (lower) than a predetermined voltage value (a predetermined voltage value stepped down by the regulator 16), and issues an instruction in accordance with the determination result. As the above range, for example, an upper limit value and a lower limit value can be set in advance. In such a case, as illustrated in FIG. 4, it is preferable that, for example, the regulator 16 is configured to set the upper limit value and the regulator 161 is configured to set the lower limit value using another set of the regulator 16 and the comparator (the regulator 161 and the comparator). At this time, it is preferable to input a voltage divided by the resistor R31 and the resistor R41 as the voltage input to the comparator used together with the regulator 161. In addition, the sensor module 1 may also be configured without the detection unit 18.

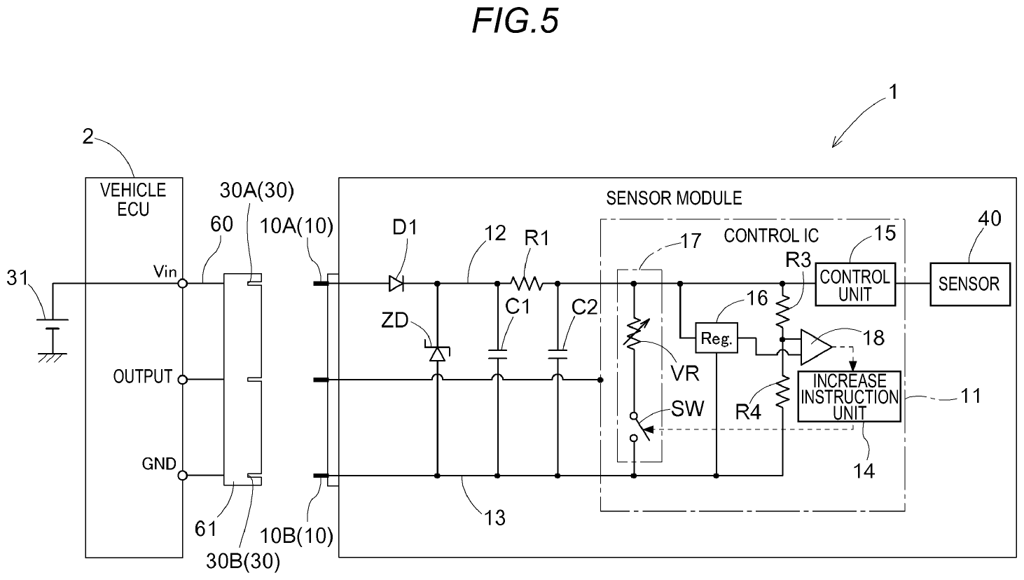

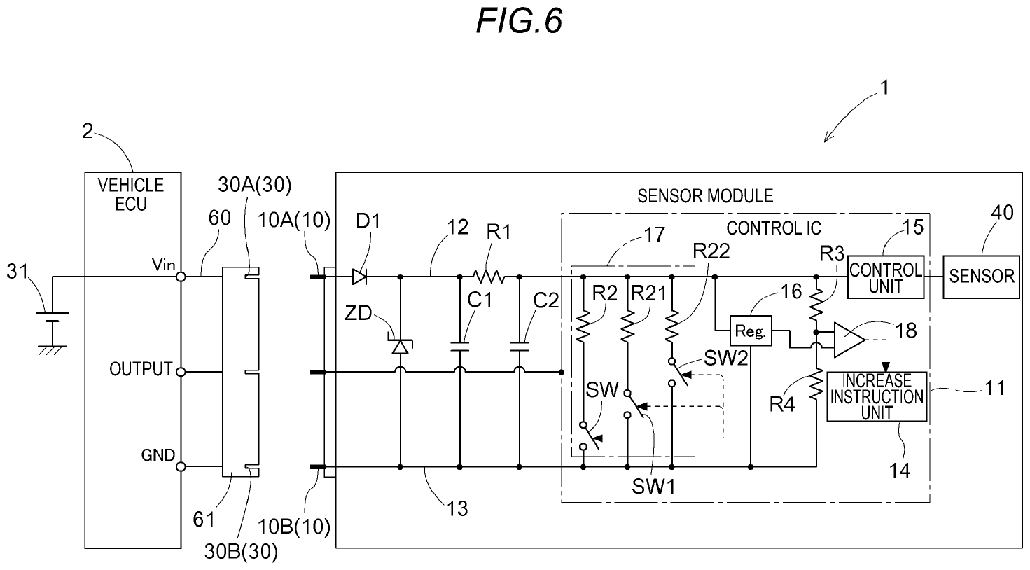

The above embodiment has been described in which the current increase unit 17 includes the resistor R2 that sets the current value of a current to be increased, and the switch SW that is connected in series with the resistor R2 and is controlled to be opened and closed in accordance with the instruction, but the current increase unit 17 may also be configured to increase the current with a configuration different from the resistor R2 and the switch SW. In addition, as illustrated in FIG. 5, a variable resistor VR whose resistance value can be changed may be used instead of the resistor R2 in FIG. 1, and as illustrated in FIG. 6, a circuit in which a resistor R21 and a switch SW1 are connected in series or a circuit in which a resistor R22 and a switch SW2 are connected in series may be connected in parallel to a circuit in which the resistor R2 and the switch SW are connected in series. In this case, for example, the current value that increases in accordance with the voltage value of the power source voltage can be adjusted. At least one circuit in which the resistor and the switch to be added are connected in series may be used.

The above embodiment has been described in which the resistor R2 and the switch SW are incorporated in the control IC 11, but the resistor R2 and the switch SW may also be configured to be externally attached to the control IC 11.

The above embodiment has been described in which the increase instruction unit 14 issues an instruction after the completion of activation of the sensor 40, but the increase instruction unit 14 may also be configured to issue an instruction regardless of the completion of activation of the sensor 40.

The above embodiment has been described in which the increase instruction unit 14 issues an instruction when the control IC 11 does not drive the sensor 40 at a predetermined time interval, but the increase instruction unit 14 may interrupt the control of the control IC 11 for driving the sensor 40 and issue an instruction.

The embodiment disclosed here can be used in a sensor module including a control IC that is supplied with electric power from the outside via a connector and controls a sensor.

A feature of a sensor module according to this disclosure is that the sensor module includes: a module side connection unit connected to a power source via a power source side connection unit; a control IC energized from the power source via the power source side connection unit and the module side connection unit and configured to control a sensor; a first power source line provided across the module side connection unit and the control IC; an increase instruction unit configured to issue an instruction to increase a current flowing through the power source side connection unit and the module side connection unit; and a current increase unit provided across the first power source line and a second power source line to which a potential lower than that of the first power source line is applied, and configured to increase the current in accordance with the instruction of the increase instruction unit.

With such a characteristic configuration, a higher current than during normal operation of the control IC can be caused to flow through the first power source line. In addition, by causing a higher current to temporarily flow, for example, when an insulating film is formed on the power source side connection unit or the module side connection unit, the insulating film can be easily broken. As described above, since the insulating film can be easily broken by the increase of the current, an influence of the insulating film can be decreased with an inexpensive configuration.

In addition, it is preferable that a current value of the current after an increase is a current value at which an insulating film formed on at least one of the power source side connection unit and the module side connection unit is dielectrically breakable.

With such a configuration, the oxide film can be dielectrically broken by temporarily flowing a high current so as to prevent a conduction failure and improve the transmission efficiency of electric power supply. Therefore, a stable voltage can be supplied. In addition, it is not necessary to use gold plating or the like in order to prevent formation of the insulating film, and therefore, an increase in cost can be prevented.

In addition, it is preferable that the increase instruction unit issues the instruction after a preset time elapses after start of energization of the control IC.

With such a configuration, when the control IC is initialized immediately after the start of energization, the control IC can be appropriately initialized.

In addition, it is preferable that a detection unit configured to detect a potential difference of the first power source line with respect to the second power source line is further provided, and the increase instruction unit issues the instruction when a detection result of the detection unit is out of a preset range.

With such a configuration, the current can be increased in accordance with a voltage value of a voltage applied to the first power source line.

In addition, it is preferable that the current increase unit includes a resistor configured to set a current value of a current to be increased, and a switch connected in series with the resistor and configured to be controlled to be opened and closed in accordance with the instruction, and the resistor and the switch are incorporated in the control IC.

With such a configuration, the current can be increased or the increase of the current can be stopped by opening and closing control of the switch, and therefore, the control can be facilitated. Therefore, switching between a state where the current is increasing and a state where the current is not increasing can be appropriately performed. In addition, the number of components can be decreased by incorporating the resistor and the switch in the control IC. Furthermore, since the current can be increased or the increase of the current can be stopped by switching the opening and closing state of the switch, the load on the power source can be decreased.

In addition, it is preferable that the increase instruction unit issues the instruction after completion of activation of the sensor.

With such a configuration, the sensor can be appropriately initialized, and therefore, the sensor can be appropriately controlled.

In addition, it is preferable that the control IC drives the sensor at a predetermined time interval, and the increase instruction unit issues the instruction when the control IC does not drive the sensor.

With such a configuration, the current is not increased during the operation of the sensor, and therefore, variation of the voltage value due to the increase of the current can be prevented, and the sensor can be appropriately controlled.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A sensor module comprising:
a module side connection unit connected to a power source via a power source side connection unit;
a control IC energized from the power source via the power source side connection unit and the module side connection unit and configured to control a sensor;
a first power source line provided across the module side connection unit and the control IC;
an increase instruction unit configured to issue an instruction to increase a current flowing through the power source side connection unit and the module side connection unit; and
a current increase unit provided across the first power source line and a second power source line to which a potential lower than that of the first power source line is applied, and configured to increase the current in accordance with the instruction of the increase instruction unit.

2. The sensor module according to claim 1, wherein
a current value of the current after an increase is a current value at which an insulating film formed on at least one of the power source side connection unit and the module side connection unit is dielectrically breakable.

3. The sensor module according to claim 1, wherein
the increase instruction unit issues the instruction after a preset time elapses after start of energization of the control IC.

4. The sensor module according to claim 1, further comprising:
a detection unit configured to detect a potential difference of the first power source line with respect to the second power source line, wherein
the increase instruction unit issues the instruction when a detection result of the detection unit is out of a preset range.

5. The sensor module according to claim 1, wherein
the current increase unit includes a resistor configured to set a current value of a current to be increased, and a switch connected in series with the resistor and configured to be controlled to be opened and closed in accordance with the instruction, and
the resistor and the switch are incorporated in the control IC.

6. The sensor module according to claim 1, wherein
the increase instruction unit issues the instruction after completion of activation of the sensor.

7. The sensor module according to claim 1, wherein
the control IC drives the sensor at a predetermined time interval, and
the increase instruction unit issues the instruction when the control IC does not drive the sensor.
